(19) United States
(12) Patent Application Publication
(10) Pub. No.: US 2014/0059445 A1
(43) Pub. Date: Feb. 27, 2014

(54) MOBILE DEVICE WITH GRAPHICAL USER INTERFACE FOR REMOTELY DETECTING AND CONNECTING TO A BUILDING AUTOMATION SYSTEM

(71) Applicant: TRANE INTERNATIONAL INC., Piscataway, NJ (US)

(72) Inventors: Susan M. Mairs, St. Paul, MN (US); Bryan George Kinney, Stillwater, MN (US); Kimberly Hayman, Minneapolis, MN (US); Melissa Rose Schumann, Brooklyn Park, MN (US); Rachel Michael Nilsson, Minneapolis, MN (US); Jacob Larson, Minneapolis, MN (US)

(73) Assignee: TRANE INTERNATIONAL INC., Piscataway, NJ (US)

(21) Appl. No.: 13/972,437

(22) Filed: Aug. 21, 2013

Related U.S. Application Data
(60) Provisional application No. 61/691,540, filed on Aug. 21, 2012.

(51) Int. Cl. G06F 3/0488; G06F 3/0481

(52) U.S. Cl. CPC G06F 3/0488; G06F 3/04817
USPC 715/740

(57) ABSTRACT

A mobile device with a graphical user interface (GUI) for remotely detecting and/or connecting to a configurable building automation systems (BAS). In particular, GUI of the mobile device provides a user to connect quickly to a detected and/or known BAS, for monitoring and/or interacting with the BAS.

### FIELD

This disclosure generally relates to a mobile device with a graphical user interface for remotely detecting and connecting to a building automation system and/or a device of the building automation system.

### BACKGROUND

A Building automation system (BAS) is used to coordinate, manage, and automate control of diverse environmental, physical, and electrical building subsystems, particularly HVAC and climate control, but also including security, lighting, power, and the like.

Hardwiring and programming of a BAS can create a robust fixed system customized for a particular installation. However, monitoring and maintenance of the BAS are still generally labor-intensive tasks that vary with each system implementation, In a common scenario, a user managing a building site must be at the location of the BAS and use a computer or other device hardwired to the BAS. If there is an issue with how the BAS is operating, the user managing the building site must physically be at the BAS to monitor the issue and to resolve the issue. If the user is not physically at the BAS location and receives notification that there is an issue with the BAS, generally, the user must physically go to the BAS location to monitor and to resolve the issue.

### SUMMARY

The embodiments described herein relate to a mobile device for interacting with a BAS remotely. Preferred embodiment relate to the mobile device for interacting with HVAC (heating, ventilation, and air conditioning) related aspects of the BAS.

In particular, the graphical user interface (GUI) of the mobile device provides a user to connect quickly to a detected and/or known BAS, for monitoring and/or interacting with the BAS. The mobile device comprises a processor in communication with a network interface and a touchscreen. The network interface can receive data from the BAS in real time, the network interface can send the data to the processor, and the processor can display the data in a portion of the GUI. The processor can execute the instructions for a GUI and displays the GUI on the touchscreen.

The GUI includes a plurality of icons, each of the icons is associated with a detected and/or known BAS and/or a device of the BAS. The plurality of icons can be displayed in the GUI as a list. The GUI can also include a range of the mobile device to the detected and/or known BAS. The term range can include signal strength of the network (e.g. WiFi, cellular, 3G, 4G, etc.) that would be used to connect to the detected and/or known BAS. The term range can be a binary indicator which indicates whether the connection is available or not available. The range can be shown graphically and/or in color so that the range information can be easily perceived and understood by a user. A selection of one of the icons by touching the touchscreen is detectable by the processor to remotely and/or wirelessly connect to the selected BAS and/or device of the BAS.

Further, the GUI is configured to allow a user to enter identification information of a BAS and/or a device of the BAS. The GUI is configured to allow a user to enter login identification and/or passcode when connecting to a secured BAS and/or device of the BAS. That is, login identification and/or passcode of the network or the BAS. Accordingly, the GUI is configured to receive user input data via the touchscreen, relay the user input data to the processor, the processor is configured to send the user input data to the BAS via a transmission from the network interface.

An embodiment of the GUI of the mobile device is configured to allow a user to enter a device identification information (such as, but not limited to, a network address of the device, internet protocol address of the device, name of the device, etc.) of a BAS (or one of the device of the BAS) via the touchscreen, the processor receives the device identification information and connect via the network interface to the BAS according to the device identification information.

In another embodiment, the mobile device has a GUI that is configured to allow a user to enter a user data, and the user data is stored in the memory. The user data is a personal identification information of the person (i.e. name of the person, contact information, personal authorization level, etc.) using the mobile device, for accessing secured system, wherein the user data can be used to verify authorization and/or authorization levels of the user who operates the BAS.

### BRIEF DESCRIPTION OF THE DRAWINGS

Referring now to the drawings in which like reference numbers represent corresponding parts throughout.

FIG. 1 is a cartoon diagram of a building automation system (BAS) connected to a mobile device according to one embodiment.

FIG. 2 is a schematic diagram of a mobile device according to one embodiment.

FIG. 3 is a graphic user interface diagram according to an embodiment.

FIG. 4 is a graphic user interface diagram according to an embodiment.

FIG. 5 is a graphic user interface diagram according to an embodiment.

### DETAILED DESCRIPTION

The embodiments described herein are directed to a mobile device with a graphical user interface for remotely monitoring and/or operating a building automation system.

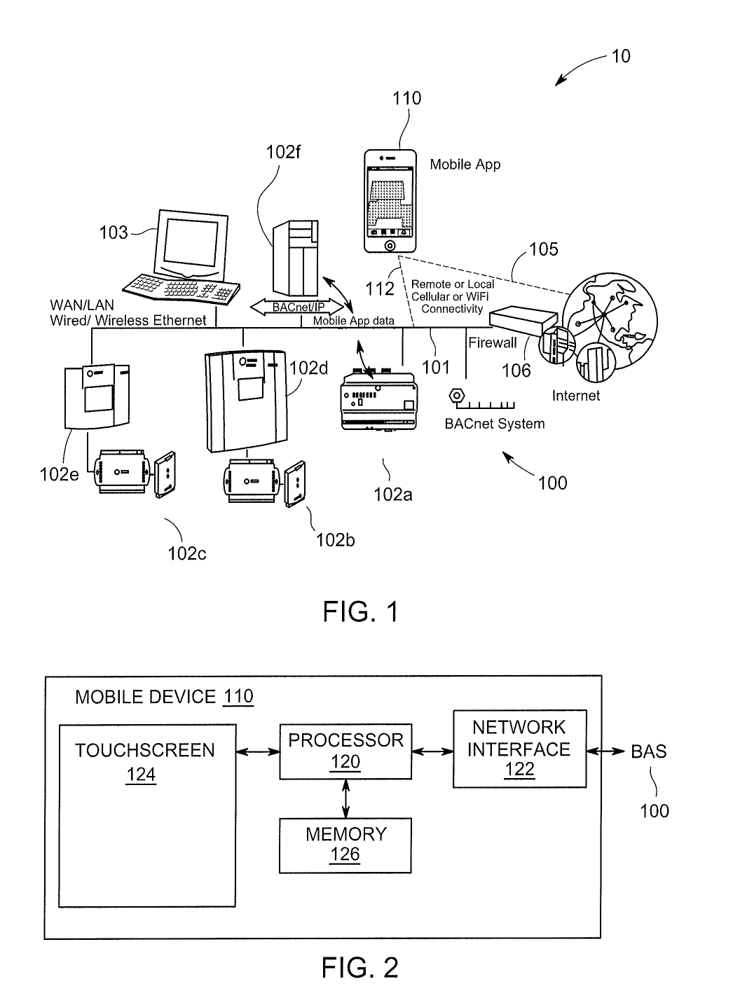

FIG. 1 shows a cartoon of a system 10 including an embodiment of a BAS 100 that includes a hardwired network 101 that uses a communication standard or protocol to link various subsystems, such as a system control unit 102a, a unit control device 102b, 102c, and/or other devices 102d, 102e, 102f, and provide a system-wide user access and control from a computer 103 hardwired to the network. The BAS 100 is connected to the internet 105, and includes a network security device 106, such as a firewall, that secures and protects the BAS 100 from unwanted intrusion via the internet 105.

The embodiment includes a mobile device 110 connectable to the BAS 100 via the internet 105, accessing the BAS 100 through the network security device 106. The mobile device 110 can connect to the BAS 100 via a local wireless connection 112. The local wireless connection 112 can be established behind the network security device 106, so that the mobile device 110 can connect to one or more of the components or devices 102a-f of the BAS 100 without requiring the communication between the mobile device 110 and the BAS 100 to go through the network security device 106.

The mobile device 110 can connect to the BAS 100 via the internet 105 using cellular, 3G, 4G, or other wireless communication protocol. The mobile device 110 can connect to the BAS 100 via the local wireless connection 112 using WiFi, bluetooth, or other wireless communication protocol. The mobile device 110 can connect to the BAS 100 using a combination of the internet 105 and local wireless connection 112.

The mobile device 110 can detect various devices of the BAS 100. The mobile device 110 can also identify the devices within range of the mobile device 110. The mobile device 110 can also determine a range, i.e. whether the mobile device 110 can connect to the BAS 100 and/or a component associated with the BAS 100 or not, and display the range on a touchscreen of the mobile device 110. Accordingly, the range can be a binary indicator which indicates whether the connection to the BAS 100 is available or not available.

FIG. 2 shows an illustrated schematic diagram of an embodiment of a mobile device 110. The mobile device 110 includes a processor 120 in communication with a network interface 122 and a touchscreen 124. The touchscreen 124 is a combination display and a human-computer interface device. The touchscreen 124 displays images as instructed by the processor 120. The touchscreen 124 can detect user input via touch or contact by a human finger or a stylus device, and sends the input to the processor 120. A memory 126 is in communication with the processor 120, and the memory 126 stores instructions for an operating system that is executed by the processor 120. The memory 126 can also store instructions for a computer program that is executed by the processor 120. The computer program includes a graphical user interface (GUI) for remote operation of a BAS 100.

Embodiments of the mobile device 110 include, but are not limited to, a smartphone, an iPhone, an iPad, an iPod, an Android phone, an Android tablet, a Windows phone, a Windows tablet, etc. Embodiments of the operating system include, but are not limited to, iOS, Android OS (e.g. Donut, Eclair, Gingerbread, Honeycomb, Ice Cream Sandwich, Jelly Bean, etc.), Windows, etc. Embodiments of the computer program include, but are not limited to, software for mobile device 110s commonly called an “App” or “Mobile App,” a script written in a scripting language, etc.

According to an embodiment, a graphical user interface (GUI) is displayed on the touchscreen 124 when the computer program instructions are executed by the processor 120, the GUI displays information to a user and also provides various input points for the user to interact with the GUI so that the user is allowed to provide input, such as operational commands or data request, which is sent to the processor 120. The processor 120 can then process the input according to the computer program instructions being executed and can communicate with the memory 126 and/or network interface 122 to provide data to be displayed on the touchscreen 124.

An embodiment of a computer program is stored on a computer readable medium, wherein the computer program includes computer readable instructions that can be executed by a processor 120 to display a GUI on a touchscreen 124 configured to provide data output on the touchscreen 124, and at the same time, receive operational input for remotely interacting with a BAS 100. The data output provided can be in real time, as the data is received from the BAS 100 to the mobile device 110 via the network interface 122 of the mobile device 110.

Accordingly, a user of the mobile device 110 can be located almost anywhere and connect to the BAS 100, as long as a wireless connection is available.

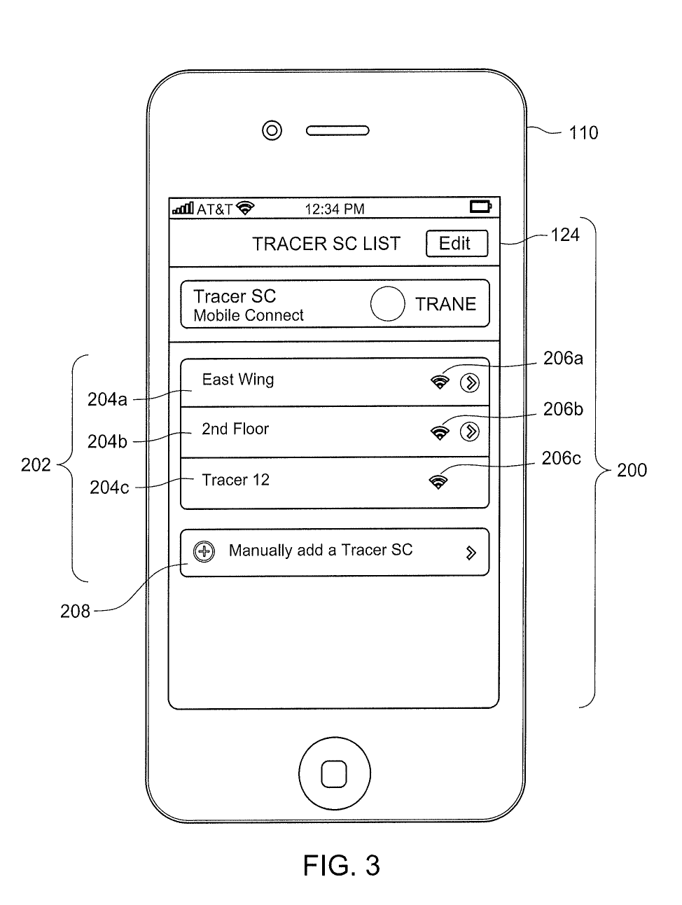

FIG. 3 shows an illustration of an embodiment of a mobile device 110 with a GUI 200 including a selection screen 202 for remotely detecting and/or connecting to a BAS. The mobile device 110 includes a network interface that can receive data from the BAS in real time, and the network interface can send the data to a processor of the mobile device 110, and the processor can display the data in a portion of the GUI 200. The GUI 200 shows a plurality of icons 204a, 204b, 204c, wherein each of the icons is associated with a detected BAS, or a component associated with the BAS, such as, but is not limited to, a device, a unit, a system, a subsystem, a controller, a space, a building, a room, etc. The component may be the condenser or the evaporator, the unit may be a chiller, the system can be a HVAC system or circuit, the subsystem can be a control system for the HVAC system.

The processor executing the instructions of the GUI 200 can also determine a type and/or identity of the detected BAS (or the device of the BAS) and show the identification information in the GUI 200. Further, the GUI 200 shows any known BAS based on saved data stored in the memory.

The plurality of icons 204a-c is displayed as a list 202 in the GUI 200. Each of the icons also shows network range 206a, 206b, 206c information for each of the BAS. For example, the GUI 200 shows that the range indicated by the range icon 206a is strong (i.e. can easily establish connection), while the range indicated by the range icon 206c is not strong (i.e. difficult to establish connection). It will be understood that other forms of displaying the list and network range are also possible.

The GUI 200 of the mobile device 110 is configured to receive a user selection of one of the icons displayed in the list 202 via a touch of the touchscreen 124. The user selection is then communicated to the processor, wherein the processor communicates to the BAS associated with the selected icon and communicates via the network interface in order to establish a connection with the BAS. Further, the GUI 200 can also send authorization data stored in the memory to the BAS via the network interface.

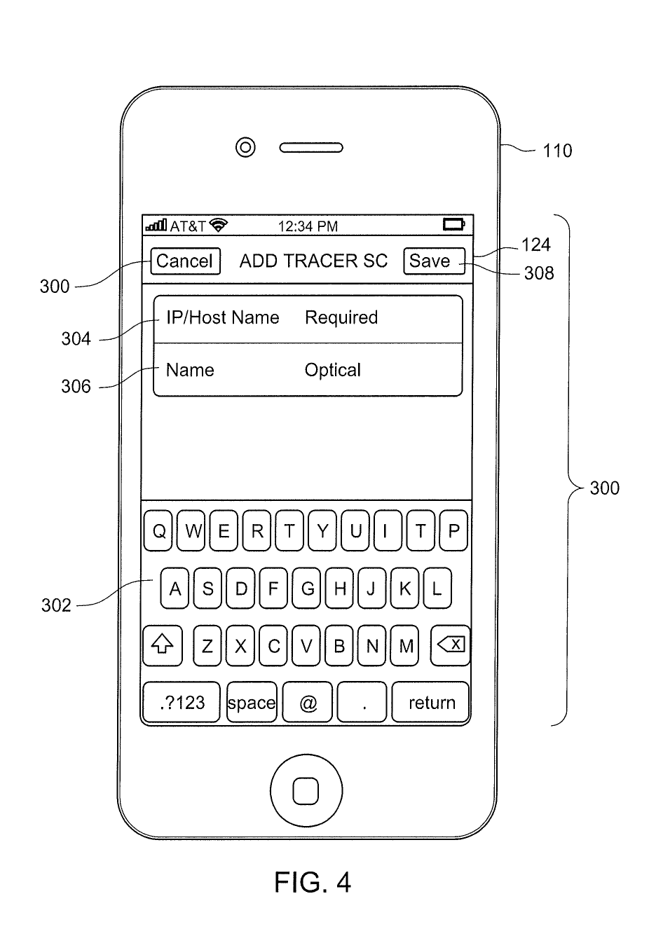

The GUI 200 includes an icon 208 for manually adding a known BAS (or device of the BAS) to the list of icons 202. When this ADD icon 208 is selected, a GUI according to, for example, FIG. 4 is displayed on the touchscreen 124 of the mobile device 110.

FIG. 4 shows an embodiment of a GUI 300 for adding a known BAS (or a device of the BAS) to the list of icons in the selection screen (e.g. FIG. 3). The GUI 300 includes a keyboard field 302 for allowing a user to enter information into identification field 304 and/or name field 306 for the BAS the user wishes to be displayed on the selection screen (e.g. FIG. 3).

The GUI 300 includes a CANCEL icon 310, which when selected, does not save the entered information to the memory and the GUI 300 returns to the selection screen (e.g. FIG. 3).

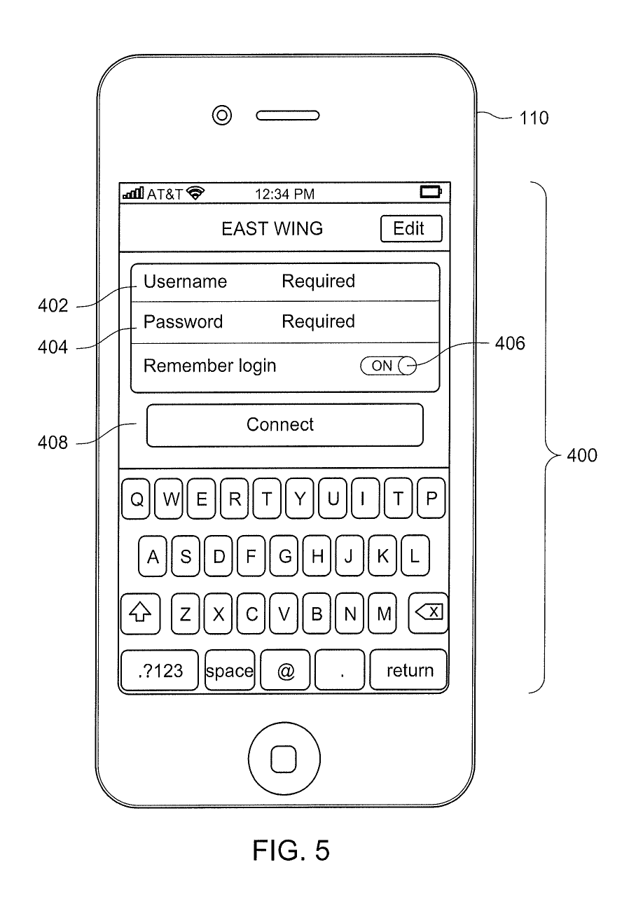

The GUI 300 also includes a SAVE icon 308 for saving the entered information into the memory of the mobile device 110. When the SAVE icon 308 is selected by a user the GUI 300 can return to the selection screen (e.g. FIG. 3), with a new icon in the list of icons showing the newly entered BAS information, or the GUI 300 can proceed to connect to the newly added BAS, for example via the GUI 400 shown in FIG. 5.

FIG. 5 shows an embodiment of a GUI 400 for the mobile device 110 that is configured to allow a user to enter a user data into a username field 402 and a password field 404 in order to accessing a secured BAS. The GUI 400 can be displayed when one of the BAS is selected from the list of icons shown in FIG. 3. The GUI 400 can also be displayed when a user completes entering information for adding the known BAS, as described above for FIG. 4.

The GUI 400 includes a slider 406, providing a choice to the user for storing the entered user data in a memory of the mobile device 110. When the REMEMBER LOGIN slider 406 is ON, then the user data entered into the username field 402 and password field 404 are stored into the memory. After the user data is stored into the memory, the user does not need to fill in the user data fields 402, 404 again. User data is personal identification information of the person using the mobile device, for accessing secured system and/or device, and the user data can be used to verify authorization and/or authorization levels of the user who operates the BAS.

The CONNECT icon 408 is provided by the GUI 400. When the user touches the CONNECT icon 408, the mobile device connects to the selected BAS (or a device of the BAS) and transmits the user data to the BAS.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What is claimed is:

1. A mobile device for remotely interacting with a building automation system, comprising:
a processor in communication with a memory, a network interface, and a touchscreen;
the processor can execute instructions for a graphical user interface and display the graphical user interface on the touchscreen,
the network interface can receive data from the building automation system in real time, the network interface can send the data to the processor, and the processor can display the data in a portion of the graphical user interface,
the graphical user interface includes a plurality of icons, each of the icons is associated with a detected building automation system based on the data received by the network interface and/or a known building automation system based on saved data stored in the memory.

2. The mobile device according to claim 1, wherein the plurality of icons is displayed as a list in the graphical user interface.

3. The mobile device according to claim 1, wherein the graphical user interface is configured to receive a user selection of one of the building automation system networks via a touch of the touchscreen, the user selection is communicated to the processor, wherein the processor communicates to the selected one of the building automation system networks via the network interface to establish a network connection therewith.

4. The mobile device according to claim 1, wherein the graphical user interface allows a selection of one of the icons by touching the touchscreen, which is detectable by the processor for sending authorization data stored in the memory to the building automation system via the network interface to remotely connect to the building automation system associated with the selection.

5. The mobile device according to claim 1, wherein the graphical user interface includes a network range information for each of the icons.

6. The mobile device according to claim 1, wherein the graphical user interface is configured to allow a user to enter a device identification information of a building automation system via the touchscreen, the processor receives the device identification information and connect via the network interface to the building automation system according to the device identification information.

7. The mobile device according to claim 6, wherein the graphical user interface is configured to allow a user to enter a user data, and the user data is stored in the memory.
